(19) United States
(12) Patent Application Publication
(10) Pub. No.: US 2004/0170259 A1
(43) Pub. Date: Sep. 2, 2004

(54) Internet video phone

(76) Inventor: Jae Hun Park, Seoul (KR)

Correspondence Address: HARNESS, DICKEY & PIERCE, P.L.C., P.O. BOX 828, BLOOMFIELD HILLS, MI, 48303, US

(21) Appl. No.: 10/704,039

(22) Filed: Nov. 7, 2003

(30) Foreign Application Priority Data
Feb. 28, 2003 (KR) 2003-12536

(51) Int. Cl. H04L 12/66; H04N 7/14

(52) U.S. Cl. 379/88.17; 348/14.01; 370/352; 379/114.01

(57) ABSTRACT

Disclosed herein is an Internet video phone. The Internet video phone has a display unit, a camera unit, a Local Area Network (LAN) interface and a control unit. The Internet video phone includes an interface that is adapted to be controlled by the control unit and to exchange data with a smart card reader that writes and reads data on and from a smart card, thus being capable of Transmission Control Protocol (TCP)/Internet Protocol (IP)-accessing a server via the Internet at the time of smart card charging and an electronic payment, and transmitting/receiving payment information to and from the server.

### BACKGROUND OF THE INVENTION

1. Field of the Invention

The present invention relates generally to an Internet video phone having an electronic payment function and, more particularly, to the provision of an electronic payment function for an Internet video phone through the smart card reader interface of the Internet video phone.

2. Description of the Related Art

A conventional Public Switched Telephone Network (PSTN) smart card terminal 10, as shown in FIG. 1, is connected to a bank server 20 or an electronic payment server 18 through a central office exchange 12 and a gateway 14 via the Internet 16, mainly using a modem.

The conventional PSTN smart card terminal performs the charging of electronic money or the on-line deposit and withdrawal of funds by exchanging packets using a modem according to an exclusive protocol.

Meanwhile, a typical credit card payment is performed in such a way as to perform a payment by exchanging credit card information while a credit card payment terminal is connected with a payment server through a modem positioned in the credit card payment terminal installed in an establishment, and a telephone line. In this case, since the telephone line is used while the payment is performed via the telephone line, this case is inconvenient in that a call cannot be placed to the outside through a telephone. Alternatively, affiliated establishments in which a large number of credit card payments are performed, such as large-sized restaurants and gas stations, employ exclusive lines instead of regular telephone lines so as to reduce telephone charges and the times required for credit card payments. This case is also inconvenient in that a telephone function cannot be supported, so that an additional telephone line should be used.

The prior art is disadvantageous in that a lengthy period of time is required and a telephone cannot be used while an electronic payment, smart card charging, or the deposit or withdrawal of funds is performed.

Additionally, the prior art is disadvantageous in that it supports only a smart card function, so that it cannot be used for other uses.

### SUMMARY OF THE INVENTION

Accordingly, the present invention has been made keeping in mind the above problems occurring in the prior art, and an object of the present invention is to provide an Internet video phone, which is interfaced with a smart card reader, so that various functions, including the functions of smart card charging and electronic payment, can be utilized via the Internet that supports a data rate greater than an existing PSTN and incurs a small network use expense, and so that a telephone can be used while an electronic payment is performed.

In order to accomplish the above object, the present invention provides an Internet video phone, the Internet video phone having a display unit, a camera unit, a Local Area Network (LAN) interface and a control unit, including an interface adapted to be controlled by the control unit and to exchange data with a smart card reader that writes and reads data on and from a smart card, thus being capable of Transmission Control Protocol (TCP)/Internet Protocol (IP)-accessing a server via the Internet at the time of smart card charging and an electronic payment, and transmitting/receiving payment information to and from the server.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration diagram showing a conventional electronic payment system using a PSTN smart card terminal;

FIG. 2 is a configuration diagram showing an electronic payment system using an Internet video phone in accordance with the present invention; and

FIG. 3 is a configuration diagram showing an Internet video phone interfaced with a smart card reader in accordance with the present invention.

### DESCRIPTION OF THE PREFERRED EMBODIMENTS

Hereinafter, the construction and operation of an embodiment of the present invention will be described with reference to the accompanying drawings.

A smart card (Integrated Circuit (IC) card) is analogous to a microcomputer that is equipped with a memory and a processor.

Since the smart card is equipped with a Chip Operating System (COS), such as MULTOS, the smart card is superior to a credit card in view of security.

With this superiority, the smart card is advantageous in that the smart card enables the exchange of payment data over the Internet, which is lacking in security, without an additional cryptographic algorithm.

With attention being paid to such outstanding security of the smart card, the present inventor attains the present invention in which an Internet video phone and a smart card reader are interfaced with each other to allow smart card charging and an electronic payment to be performed on the Internet without additional expenses.

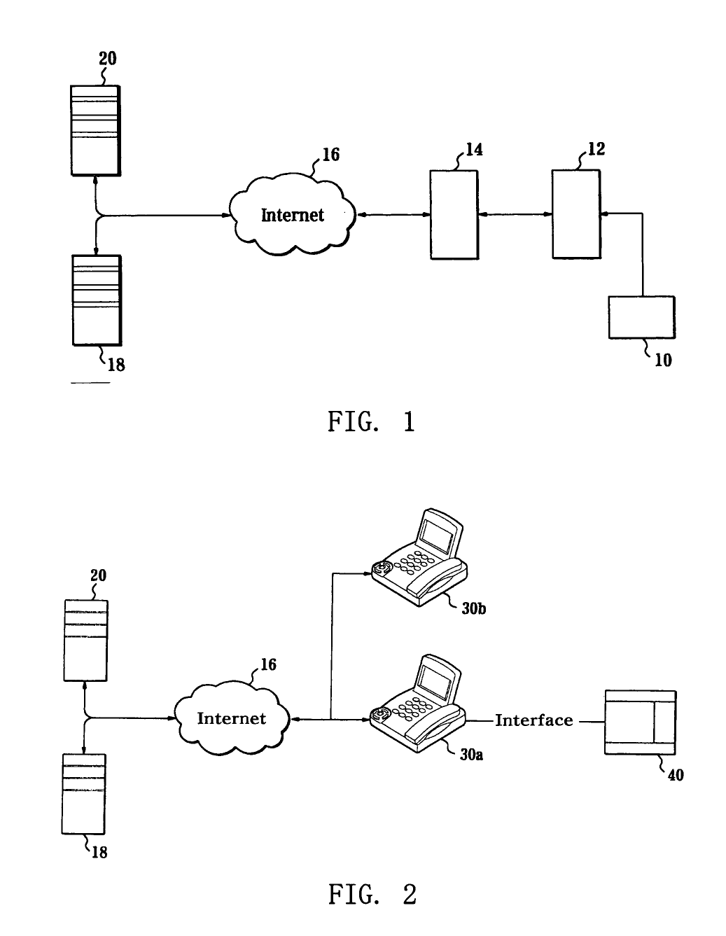

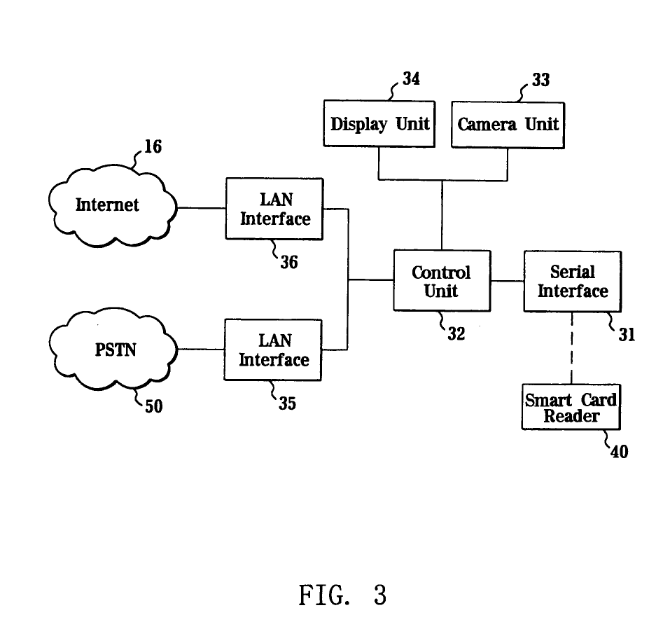

FIG. 2 is a configuration diagram showing an electronic payment system using an Internet video phone in accordance with the present invention.

The Internet video phone interfaced with a smart card reader, as shown in FIG. 2, is connected to the Internet 16 through a Local Area Network (LAN), a cable modem and an Asynchronous Digital Subscriber Line (ADSL), and the Internet 16 is connected to a bank server 18 or an electronic payment server 20.

Additionally, the Internet video phone is provided with an additional interface port, so that the Internet video phone can exchange data with a smart card reader 40 while being connected with the smart card reader 40.

When the user selects a smart card on-line payment item from a menu, the Internet video phone 30a obtains data required for on-line payment by writing and reading data on and from the smart card through the smart card reader 40, accesses the electronic payment server 18 or bank server 20 via the Internet 16, and exchanges data with the electronic payment server 18 or bank server 20.

That is, a user TCP/IP-accesses a server 18 or 20 using the Internet video phone 30a via the Internet 16 at the time of the smart card charging and the electronic payment, and transmits and receives payment information to and from the server 18 or 20.

The smart card reader 40 satisfies the international smart card standards of International Organization for Standardization (ISO)/International Engineering Consortium (IEC) 7816, is interfaced with the Internet video phone through a serial port, and can be attached to and detached from the Internet video phone.

Additionally, the user can call another Internet video phone using the Internet video phone 30a via the Internet 16, which is the intrinsic function of the Internet video phone 30a.

FIG. 3 is a configuration diagram showing an Internet video phone interfaced with a smart card reader in accordance with the present invention.

An Internet video phone 30a interfaced with a smart card reader 40, as shown in FIG. 3, includes a control unit 32, a display unit 34, a camera unit 33, a LAN interface 36, a PSTN interface 35, and a serial interface 31.

The control unit 32 controls all the operations of the Internet video phone 30a, including voice input/output, image processing, and the operations of a main memory unit and a processor.

The display unit 34 outputs data on the screen thereof.

Since the Internet video phone 30a should output the image of an opposite party on the screen thereof, the Internet video phone 30a uses a large-sized color Liquid Crystal Display (LCD) as the screen thereof.

Accordingly, since a large number of contents can be displayed on the screen of the Internet video phone 30a, user-friendly smart card-related menu and functions can be added to the contents that can be displayed on the screen of the Internet video phone 30a.

The camera unit 33 functions to receive the image of the user.

The LAN interface 36 interfaces the Internet video phone 30a with the Internet 16 to allow the Internet video phone 30a to be used on the Internet 16.

The PSTN interface 35 interfaces the Internet video phone 30a with the PSTN 50 to allow the Internet video phone 30a to be used in conjunction with the PSTN 50, like a typical telephone.

The serial interface 31 interfaces the Internet video phone 30a with the smart card reader 40 based on serial interface such as RS-232 standards so that the Internet video phone 30a exchanges data with the smart card reader 40.

The user can use the Internet video phone 30a as an Internet video phone that can support the functions of smart card charging and electronic payment.

As described above, the Internet video phone 30a is interfaced with the smart card reader 40, so that various functions, such as the functions of smart card charging and electronic payment, can be utilized via the Internet 16 that supports a data rate greater than an existing PSTN and incurs a small network use expense, and so that a telephone can be used while the electronic payment is performed.

In accordance with the present invention, the following effects can be obtained.

First, the Internet video phone 30a is interfaced with the smart card reader 40, so that various functions, such as the functions of smart card charging and electronic payment, can be utilized via the Internet 16 that supports a data rate greater than an existing PSTN and incurs a small network use expense.

Second, using the advantage of the smart card in which the smart card has desirable security because it is equipped with a Central Processing Unit (CPU), there arises no problem of security when data are exchanged over the Internet.

Third, since the Internet video phone generally uses a large-sized color Thin Film Transistor (TFT) as a display medium, a Graphic User Interface (GUI) menu can be made to be easily seen in one glance.

Furthermore, since the smart card reader can be attached or detached to and from the Internet video phone, the improvement and expansion of the functions can be easily achieved.

When the Internet video phone is one with an Internet Web browser function, products can be purchased without delay by performing an electronic payment using the smart card.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An Internet video phone, the Internet video phone having a display unit, a camera unit, a Local Area Network (LAN) interface and a control unit, comprising:
an interface adapted to be controlled by the control unit and to exchange data with a smart card reader that writes and reads data on and from a smart card, thus being capable of Transmission Control Protocol (TCP)/Internet Protocol (IP)-accessing a server via an Internet at a time of smart card charging and an electronic payment, and transmitting/receiving payment information to and from the server.

2. The Internet video phone as set forth in claim 1, wherein the smart card reader satisfies International smart card standards of International Organization for Standardization (ISO)/International Engineering Consortium (IEC) 7816, is interfaced with the Internet video phone through a serial port, and can be attached to and detached from the Internet video phone.

3. The Internet video phone as set forth in claim 1, further comprising a Public Switched Telephone Network (PSTN) interface for interfacing the Internet video phone with a PSTN to allow the Internet video phone to be used as a typical telephone when the Internet is unavailable.
